(19) United States
(12) Patent Application Publication
(10) Pub. No.: US 2016/0240828 A1
(43) Pub. Date: Aug. 18, 2016

(54) ELECTRODE GROUP AND ELECTRICITY STORAGE DEVICE USING THE SAME

(71) Applicant: SUMITOMO ELECTRIC INDUSTRIES, LTD., Osaka-shi (JP)

(72) Inventors: Mitsuyasu UEDA, Osaka-shi (JP); Masatoshi MAJIMA, Itami-shi (JP)

(21) Appl. No.: 15/023,191

(22) PCT Filed: Sep. 9, 2014
(86) PCT No.: PCT/JP2014/073726

§ 371 Date: Mar. 18, 2016

(30) Foreign Application Priority Data
Sep. 18, 2013 (JP) 2013-193565

(51) Int. Cl. H01M 2/16; H01G 11/28; H01G 11/70; H01G 11/68; H01M 10/0585; H01G 11/62; H01M 10/0525; H01M 4/66; H01M 10/0568; H01G 11/52; H01G 11/78

(52) U.S. Cl. CPC H01M 2/1673; H01G 11/52; H01G 11/28; H01G 11/70; H01G 11/68; H01G 11/78; H01G 11/62; H01M 10/0525; H01M 4/661; H01M 4/662; H01M 10/0568; H01M 10/0585

(57) ABSTRACT

An electrode group includes a plurality of first electrodes including sheet-shaped first current collectors and a first active material carried on the first current collectors, a plurality of second electrodes including sheet-shaped second current collectors and a second active material carried on the second current collectors, and sheet-shaped separators disposed between the first electrodes and the second electrodes. The first electrodes and the second electrodes are alternately stacked with the separators disposed between the first electrodes and the second electrodes, and the first current collectors each include a first metal porous body.

### TECHNICAL FIELD

The present invention relates to an electrode group and an electricity storage device which each include first electrodes, second electrodes, and separators disposed between the electrodes, and particularly to an electrode group including a metal porous body as a current collector.

### BACKGROUND ART

In recent years, electricity storage devices used for personal digital assistants, electric vehicles, household power storage devices, and the like have been developed. Among the electricity storage devices, capacitors and nonaqueous electrolyte secondary batteries have been actively studied. In particular, the development of, for example, lithium ion capacitors, electric double layer capacitors, lithium ion batteries, and sodium ion batteries is highly anticipated.

Such an electricity storage device includes an electrolyte and an electrode group that includes first electrodes, second electrodes, and separators disposed between the electrodes. Each of the electrodes includes a current collector (electrode core) and an active material layer carried on the current collector. In the related art, the current collector is generally formed of a metal foil.

To increase the capacitance of the electricity storage device, the amount of an active material carried per unit area of the current collector is desirably increased as much as possible. However, if a large amount of active material is carried on a metal foil, the thickness of the active material layer increases, which increases the average distance between the active material and the current collector. As a result, the current collecting properties of the electrode degrade, and the contact between the active material and the electrolyte is restricted, which makes it easy to impair the charge-discharge characteristics.

Thus, it has been proposed that a metal porous body with communicating pores having a high porosity be used as the current collector (refer to PTL 1 to PTL 3). The metal porous body is produced by, for example, forming a metal layer on the skeleton surface of a resin foam with communicating pores, such as a urethane foam, pyrolyzing the urethane foam, and then reducing the metal.

### CITATION LIST

### Patent Literature

PTL 1: Japanese Unexamined Patent Application Publication No. 2012-186142

PTL 2: Japanese Unexamined Patent Application Publication No. 2013-8813

PTL 3: Japanese Unexamined Patent Application Publication No. 2013-115179

### SUMMARY OF INVENTION

### Technical Problem

A metal porous body is believed to be suitable for an electrode for electricity storage devices because such a metal porous body can carry a large amount of active material due to its large surface area and can easily hold an electrolyte. However, when a plurality of electrodes each having the same polarity and including a metal porous body as a current collector are used, the current collectors having the same polarity need to be connected to each other in parallel.

For example, an electrode group 100 illustrated in FIG. 12 includes a plurality of sheet-shaped positive electrodes 112 and a plurality of sheet-shaped negative electrodes 114 which are alternately stacked on top of another with separators disposed therebetween. Each of the current collectors includes a tab-shaped connection portion 116. As illustrated in FIG. 13, a plurality of the connection portions 116 are joined to each other so that the electrodes having the same polarity are electrically connected to each other. The connection portion 116 is integrally formed with a main body of the current collector for the purpose of reducing the number of parts and the number of production steps. That is, the connection portion 116 is made of the same material as that for the current collector.

The metals are generally connected by welding. However, it is quite difficult to join the connection portions formed of a metal porous body by welding. This is because when a metal porous body is heated, the structure and properties of the porous body considerably change. Furthermore, it is difficult to precisely control the shape of a welded portion, and thus an irregular boundary is easily formed between the welded portion and the surrounding portion. As a result, the stress is locally concentrated, which makes it difficult to achieve both good conductivity and sufficient joint strength.

### Solution to Problem

According to one aspect of the present invention, there is provided an electrode group including:

a plurality of first electrodes including sheet-shaped first current collectors and a first active material carried on the first current collectors;

a plurality of second electrodes including sheet-shaped second current collectors and a second active material carried on the second current collectors; and

sheet-shaped separators disposed between the first electrodes and the second electrodes,

wherein the first electrodes and the second electrodes are alternately stacked with the separators disposed between the first electrodes and the second electrodes,

the first current collectors each include a first metal porous body,

the plurality of first current collectors include tab-shaped first connection portions each used to electrically connect the first current collectors adjacent to each other, and

the first connection portions of the plurality of first current collectors are disposed so as to overlap one another in a stacking direction of the electrode group with sheet-shaped first conductive spacers disposed therebetween, and are fastened to each other by a first fastening member.

According to another aspect of the present invention, there is provided an electricity storage device including the above electrode group, an electrolyte, and a case that accommodates the electrode group and the electrolyte.

According to still another aspect of the present invention, there is provided a lithium ion capacitor including the above electrode group, an electrolyte, and a case that accommodates the electrode group and the electrolyte,

wherein the electrolyte contains a salt of a lithium ion and an anion, and

one of the first active material and the second active material is a first material that intercalates and deintercalates the lithium ion, and the other is a second material that adsorbs and desorbs the anion.

According to still another aspect of the present invention, there is provided an electric double layer capacitor including the above electrode group, an electrolyte, and a case that accommodates the electrode group and the electrolyte,

wherein the electrolyte contains a salt of an organic cation and an anion, and

one of the first active material and the second active material is a third material that adsorbs and desorbs the organic cation, and the other is a fourth material that adsorbs and desorbs the anion.

According to still another aspect of the present invention, there is provided a nonaqueous electrolyte secondary battery including the above electrode group, an electrolyte, and a case that accommodates the electrode group and the electrolyte,

wherein the electrolyte contains a salt of an alkali metal ion and an anion, and

both of the first active material and the second active material are materials that intercalate and deintercalate the alkali metal ion.

### Advantageous Effects of Invention

When the electrode group is constituted by electrodes including a metal porous body as a current collector, both good conductivity and sufficient joint strength can be achieved between connection portions of a plurality of electrodes. Thus, the performance and durability of electricity storage devices can be improved.

### BRIEF DESCRIPTION OF DRAWINGS

FIG. 1 is a perspective view illustrating the outer appearance of an electricity storage device according to an embodiment of the present invention.

FIG. 2 is a partial sectional view illustrating the internal structure when the electricity storage device is viewed from the front.

FIG. 3A is a sectional view taken along line IIIA-IIIA of FIG. 2.

FIG. 3B is a sectional view taken along line IIIB-IIIB of FIG. 2.

FIG. 4 is a front view illustrating a first electrode in a bag-shaped separator in a state in which one of surfaces of the bag-shaped separator is removed.

FIG. 5 is a front view illustrating a second electrode.

FIG. 6A is a partial sectional view illustrating a connection structure of the first electrode and a first terminal plate.

FIG. 6B is a partial sectional view illustrating a connection structure of the second electrode and a second terminal plate.

FIGS. 7(a), 7(b), and 7(c) are a front view, a top view, and a side view illustrating a structure of a first lead, respectively.

FIG. 8 is a sectional view illustrating a preferred joint structure of an open edge of a case and a peripheral portion of the sealing plate.

FIG. 9 is a sectional view illustrating a typical joint structure of an open edge of a case and a peripheral portion of the sealing plate.

FIG. 10 schematically illustrates an example structure of a part of a skeleton of a first current collector.

FIG. 11 is a schematic sectional view illustrating a state in which the first current collector is filled with an electrode mixture.

FIG. 12 is a sectional view illustrating a known electrode group.

FIG. 13 is a sectional view illustrating a problem of the known electrode group.

FIG. 14A is an enlarged partial sectional view of an electrode group illustrating a principal part of an electricity storage device according to another embodiment of the present invention.

FIG. 14B is a partial sectional view of an electrode group illustrating a modification of the other embodiment.

FIG. 15 is a graph illustrating the measurement result of a connection resistance between an electrode and a lead in an example of the present invention.

FIG. 16 is a partial sectional view of an electrode group illustrating a structure of a first test product in which the electrode and the lead are connected by a rivet, which is the above example.

FIG. 17 is a partial sectional view of an electrode group illustrating a structure of a second test product in which the electrode and the lead are connected by ultrasonic welding, which is a comparative example against the above example.

### DESCRIPTION OF EMBODIMENTS

### Overview of Embodiments of the Invention

An electrode group according to one aspect of the present invention includes a plurality of first electrodes, a plurality of second electrodes, and sheet-shaped separators disposed between the first electrodes and the second electrodes. The plurality of first electrodes include sheet-shaped first current collectors and a first active material carried on the first current collectors. Similarly, the plurality of second electrodes also include sheet-shaped second current collectors and a second active material carried on the second current collectors. The first electrodes and the second electrodes are alternately stacked with the separators disposed between the first electrodes and the second electrodes.

The first current collector includes a first metal porous body. For example, when the first electrode is a positive electrode for lithium ion capacitors or nonaqueous electrolyte secondary batteries, a metal porous body containing aluminum is preferably used as the first current collector. When the first electrode is a negative electrode for lithium ion capacitors or nonaqueous electrolyte secondary batteries, a metal porous body containing copper is preferably used as the first current collector. The second current collector can also include a second metal porous body.

The first metal porous body and the second metal porous body may have such a porous structure that the surface area (hereafter, also referred to as an effective surface area) where an active material is to be carried is larger than that of a simple metal foil or the like. From this viewpoint, the first metal porous body and the second metal porous body are most preferably a metal porous body having a three-dimensional network hollow skeleton, such as Celmet (registered trademark of Sumitomo Electric Industries, Ltd.) or Aluminum-Celmet (registered trademark of Sumitomo Electric Industries, Ltd.), which is described below, because the effective surface area per unit volume can be considerably increased. In addition, the first metal porous body and the second metal porous body may be, for example, nonwoven fabric, punched metal, or expanded metal. Herein, nonwoven fabric, Celmet, and Aluminum-Celmet are porous bodies having a three-dimensional structure, and punched metal and expanded metal are porous bodies having a two-dimensional structure.

The plurality of first current collectors each include a tab-shaped first connection portion for achieving electrical connection with the adjacent first current collector. The first connection portions of the plurality of first current collectors are disposed so as to overlap one another in a stacking direction of the electrode group with sheet-shaped first conductive spacers disposed therebetween, and are fastened to each other by a first fastening member.

As described above, the second current collector can also include a second metal porous body. The plurality of second current collectors can also each include a tab-shaped second connection portion for achieving electrical connection with the adjacent second current collector. The second connection portions can be disposed so as to overlap one another in a stacking direction of the electrode group with a sheet-shaped second conductive spacer disposed therebetween, and can be fastened to each other by a second fastening member.

In the electrode group according to this embodiment, as described above, at least one of the electrodes includes a metal porous body as a current collector. The connection portion, for example, integrally formed with a main body of the current collector is fastened to the adjacent connection portion by a fastening member with a conductive spacer disposed therebetween. The fastening member may be, for example, a rivet. When the connection portions are mechanically joined by a fastening member such as a rivet in such a manner, the structure and properties of the metal porous body do not considerably change as in the case of welding, which can prevent the degradation of durability. Furthermore, the joint strength obtained by employing a mechanical joint method that uses a fastening member such as a rivet is several times higher than that obtained by employing a metallurgical joint method such as welding. As described below, the fastening member according to an aspect of the present invention is not limited to the rivet. Any member or tool that can mechanically join or connect the connection portions can be used as the fastening member. However, as described below, the fastening member is most preferably a rivet.

A specific method for mechanically joining the connection portions using a fastening member (first fastening member or second fastening member) will be described using an example.

In the case of a shaft-shaped fastening member, the following is conceivable. A through-hole into which a fastening member is to be inserted is formed in the connection portion, the fastening member is inserted into the through-hole, and the tip of the fastening member is squashed and engaged with the side surface of the connection portion to perform fastening. The through-hole is easily made to have, for example, a shape close to a perfect circle, and the precision of the shape is easily investigated. Thus, an excess concentration of stress can be suppressed and desired durability can be easily achieved. Furthermore, defective items with poor durability can be prevented from being shipped.

The shaft-shaped fastening member is preferably a rivet and particularly preferably a countersunk-head rivet. The use of the countersunk-head rivet can prevent the head portion (the large-diameter portion at one end in an axial direction) from protruding from the surface of the connection portions and spacers when the connection portions are fastened to each other. Herein, a countersunk hole having a shape corresponding to the shape of the head portion of the countersunk-head rivet is formed in the connection portions or the spacers.

Moreover, a contact area larger than or equal to that in the case of welding can be easily achieved by disposing a conductive spacer between the connection portions of the plurality of electrodes having the same polarity. This can decrease the connection resistance between the electrodes.

To increase the capacitance, a metal porous body having a thickness (e.g., 0.1 to 10 mm) larger than or equal to a particular thickness is preferably used as the current collector. Also in this case, the deformation of the connection portions can be suppressed by disposing a conductive spacer between the connection portions of the plurality of electrodes. This can improve the durability of the electrode group.

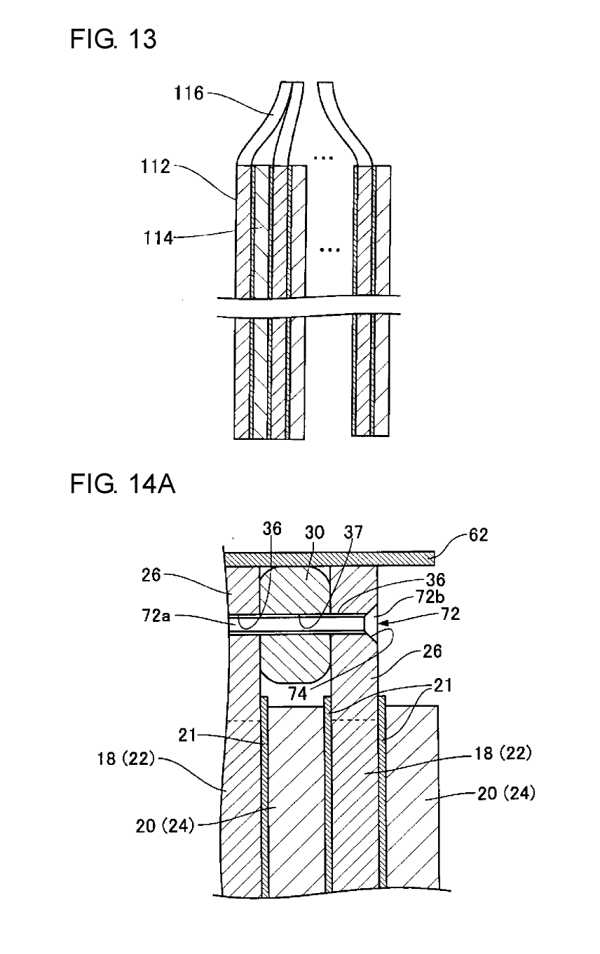

More specifically, in the electrode group having the above-described stacked structure, the distance between the connection portions of the plurality of electrodes having the same polarity is, for example, 1 mm or more. Herein, if the connection portions are directly joined to each other by a fastening member, the deformation of the connection portions 116 increases as illustrated in FIG. 13. As a result, the durability may degrade. If the conductive spacer is disposed between the connection portions of the plurality of electrodes, the deformation caused when the adjacent connection portions are joined to each other can be suppressed. This can improve the durability of the electrode group.

The first fastening member preferably contains the same metal element as the first current collector. This can suppress the erosion of the first fastening member caused by an electrolyte or the like. Thus, the durability of the electrode group can be improved. For example, when the first electrode is a positive electrode for lithium ion capacitors or lithium ion batteries, preferably, the first current collector contains aluminum or an aluminum alloy and the first fastening member also contains aluminum or an aluminum alloy. The second fastening member also preferably contains the same metal element as the second current collector. This can suppress the erosion of the second fastening member caused by an electrolyte or the like. Thus, the durability of the electrode group can be improved. For example, when the second electrode is a negative electrode for lithium ion capacitors or lithium ion batteries, preferably, the second current collector contains copper or a copper alloy and the second fastening member also contains copper or a copper alloy.

The conductive spacer (first conductive spacer or second conductive spacer) may be formed of a material having sufficient conductivity and sufficient rigidity and toughness for spacers. However, the conductive spacer preferably has cushioning properties (stress relaxation effect). In this case, the adhesion between the conductive spacer and each connection portion can be improved by applying an appropriate fastening pressure to the spacer between the adjacent connection portions. This can reduce the connection resistance between the electrodes.

From this viewpoint, the conductive spacer preferably contains a metal porous body (third metal porous body or fourth metal porous body). Therefore, the third metal porous body or the fourth metal porous body can be formed of the same material as that of the first metal porous body or the second metal porous body. Alternatively, the third metal porous body or the fourth metal porous body may be a metal foam (refer to PTL 1) foamed by adding a foaming agent to a molten metal. The metal foam includes a large proportion of closed pores, and thus is not suitably used for current collectors. However, a metal foam including a large proportion of closed pores is useful for spacers that achieve good cushioning properties.

The compression ratio (minimum thickness after fastening with fastening member/average thickness before fastening) of the conductive spacer compressed between the connection portions is preferably 1/10 to 9/10 and more preferably 5/10 to 7/10. Alternatively, the stress exerted on the conductive spacer between the connection portions is preferably 0.01 to 1 MPa and more preferably 0.1 to 0.3 MPa on average.

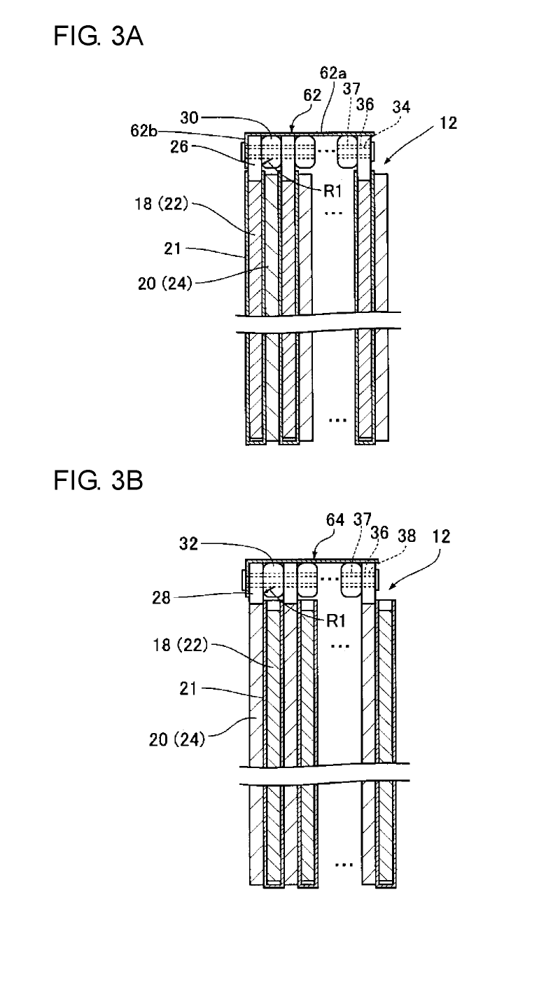

The conductive spacer (first conductive spacer or second conductive spacer) preferably has a chamfered portion at a corner corresponding to at least one of sides that contact the connection portions. The radius of curvature R1 in the chamfered portion (refer to FIG. 3A and FIG. 3B) is, for example, preferably 1 to 10 mm and more preferably 3 to 7 mm. If the conductive spacer has a sharp corner on the side that contacts the connection portion, the stress may be concentrated on a part of the connection portion. In contrast, if the conductive spacer has a chamfered portion at a corner of the side that contacts the connection portion, the stress applied to the connection portion is dispersed. This improves the durability of the connection portion and also improves the durability of the electricity storage device.

Herein, the fastening member (first fastening member or second fastening member) for fastening the connection portions is preferably a rivet. The fastening member may be, for example, a bolt and a nut. However, the use of the rivet can easily miniaturize the fastening member. Although the use of a bolt and a nut may cause “looseness”, the use of the rivet does not cause “looseness”. As a result, a desired fastened state can be maintained for a long time. Furthermore, the use of the rivet makes it easy to achieve miniaturization of the head portion.

The fastening member is not limited to a shaft-shaped fastening member. For example, a clip-shaped member (elastic member) can also be used as the fastening member. That is, a plurality of connection portions can be fastened to each other by a clip-shaped fastening member so that the stacked body of the connection portions is nipped from the outside. In this case, the clip-shaped fastening member can be used as an electrode lead, and therefore the number of members can be reduced.

Next, an electricity storage device according to an aspect of the present invention includes the above-described electrode group and an electrolyte. A metal can or a packaging container formed of a lamination film can be used for the case of the electricity storage device. Examples of the electricity storage device include capacitors such as lithium ion capacitors and electric double layer capacitors and nonaqueous electrolyte secondary batteries such as lithium ion batteries and sodium ion batteries.

In an embodiment of the lithium ion capacitor, the electrolyte contains a salt of a lithium ion and an anion. One of the first active material and the second active material is a first material (negative electrode active material) that intercalates and deintercalates lithium ions, and the other is a second material (positive electrode active material) that adsorbs and desorbs anions. The first material intercalates and deintercalates lithium ions through a Faradaic reaction. The first material is, for example, a carbon material such as graphite or an alloy-based active material such as Si, SiO, Sn, or SnO. The second material adsorbs and desorbs anions through a non-Faradaic reaction. The second material is, for example, a carbon material such as activated carbon or carbon nanotube. The second material (positive electrode active material) may be a material that causes a Faradaic reaction. Examples of the material include metal oxides such as manganese oxide, ruthenium oxide, and nickel oxide and conductive polymers such as polyacene, polyaniline, polythiol, and polythiophene. The capacitor in which the Faradaic reaction occurs in the first material and the second material is referred to as a redox capacitor.

In an embodiment of the electric double layer capacitor, the electrolyte contains a salt of an organic cation and an anion. One of the first active material and the second active material contains a third material that adsorbs and desorbs organic cations, and the other contains a fourth material that adsorbs and desorbs anions. Both the third material and the fourth material adsorb and desorb organic cations or anions through a non-Faradaic reaction. The third material and the fourth material are, for example, a carbon material such as activated carbon or carbon nanotube.

In an embodiment of the nonaqueous electrolyte secondary battery, the electrolyte contains a salt of an alkali metal ion and an anion. Both the first active material and the second active material contain a material that intercalates and deintercalates alkali metal ions. That is, a Faradaic reaction occurs in both the first active material and the second active material.

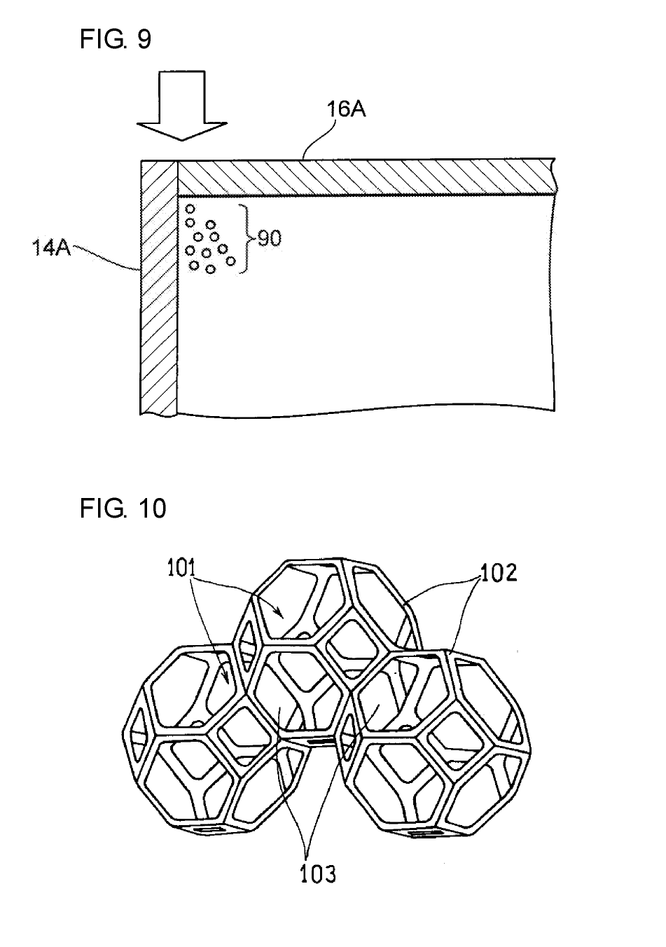

The sealing plate includes a peripheral portion having a shape corresponding to that of the open edge of the case. At least part of the peripheral portion preferably includes a first inclined surface that forms an acute angle θ1 with the outer surface of the sealing plate (refer to FIG. 8). The outer surface of the sealing plate refers to a surface located outside the case when the open edge of the case is sealed.

The open edge of the case preferably includes, in a portion that faces the first inclined surface, a second inclined surface that forms an acute angle θ2 with the outer surface of the case. In this case, the peripheral portion of the sealing plate and the open edge of the case can be joined by welding the first inclined surface and the second inclined surface. Herein, when the outer surface of the sealing plate and the outer surface of the case are perpendicular to each other, θ2=(90−θ1) (degrees).

As illustrated in FIG. 8, the peripheral portion of the sealing plate 16 and, for example, the upper end portion of the open edge of the case 14 are joined by butt-welding the inclined surfaces, whereby the influence due to dimensional errors can be reduced.

Furthermore, a weld having a length larger than that of a typical weld (refer to FIG. 9) can be formed by welding the inclined surfaces. Although the length of a weld in FIG. 9 is L12, the length of a weld in FIG. 8 is larger than L12. As a result, foreign matter generated due to sputtering or the like in the welding can be prevented from entering the case. Thus, an electricity storage device with desired performance can be more stably produced. Herein, the acute angle θ1 is preferably in the range of 5 to 85 degrees. The angle θ1 can be set to an optimum angle in the above range in accordance with the thickness of the sealing plate and the thickness of the case. The angle θ1 is more preferably in the range of 10 to 45 degrees.

When the angle θ1 is set to, for example, in the range of 5 to 85 degrees, the peripheral portion of the sealing plate and the open edge of the case are easily welded to each other. That is, when the angle θ1 is within the above range, the peripheral portion of the sealing plate and the open edge of the case can be welded by applying laser light in a direction perpendicular to the outer surface of the sealing plate as illustrated in FIG. 8. Consequently, as in the case illustrated in FIG. 9, the entire peripheral portion of the sealing plate can be welded to the open edge of the case by only two-dimensionally moving the case or a laser head without changing its posture. When the laser light is applied from obliquely above or in a direction perpendicular to the outer surface of the case (horizontal direction in FIG. 8), the case or a laser head needs to be rotated or the posture of the case or the laser head needs to be changed, which makes it difficult to perform positional control.

The thickness L11 of a portion, which is adjacent to the second inclined surface 14a, of a sidewall of the case can be set to, for example, 0.1 to 3 mm. The thickness L11 may agree with the average thickness of the entire case. Alternatively, only a portion adjacent to the second inclined surface may have a thickness L11 in the above range. The thickness L12 of a portion, which is adjacent to the first inclined surface 16a, of the sealing plate can be set to, for example, 0.1 to 4 mm. The thickness L12 may also agree with the average thickness of the entire sealing plate. Alternatively, only a portion adjacent to the first inclined surface 16a may have a thickness L12 in the above range.

### Details of Embodiments of the Invention

Hereafter, the details of embodiments of the present invention will be described with reference to the attached drawings.

### First Embodiment

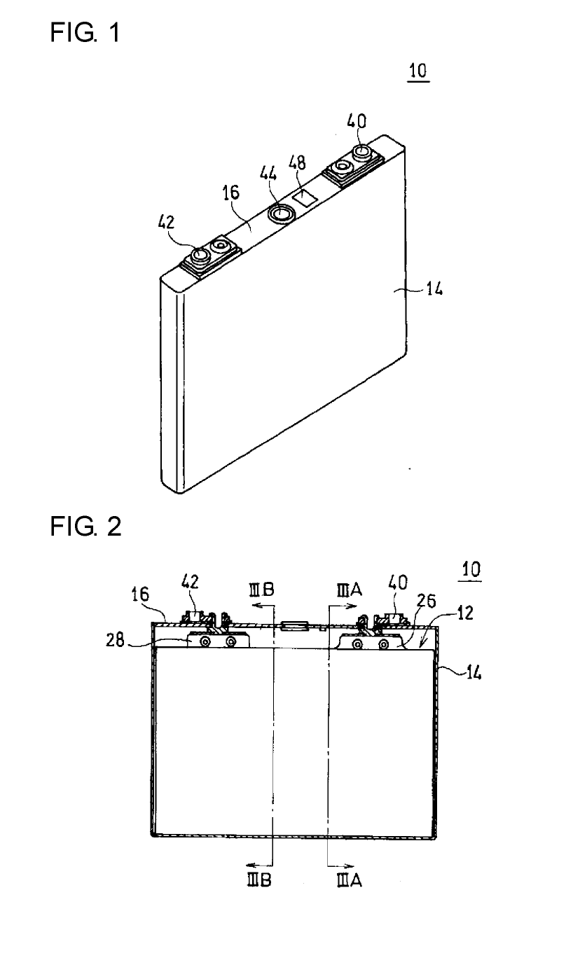

FIG. 1 is a perspective view illustrating the outer appearance of an electricity storage device including the electrode group according to a first embodiment. FIG. 2 is a partial sectional view illustrating the internal structure when the electricity storage device is viewed from the front. FIG. 3A and FIG. 3B are a sectional view taken along line IIIA-IIIA of FIG. 2 and a sectional view taken along line IIIB-IIIB of FIG. 2, respectively.

The electricity storage device 10 illustrated in the drawings is, for example, a lithium ion capacitor and includes an electrode group 12, a case 14 that accommodates the electrode group 12 together with an electrolyte (not illustrated), and a sealing plate 16 that seals an open edge of the case 14. In the drawings, the case 14 has a rectangular shape. The electricity storage device according to an embodiment of the present invention can be most suitably applied to such a rectangular case illustrated in the drawings.

The electrode group 12 includes a plurality of sheet-shaped first electrodes 18 and a plurality of sheet-shaped second electrodes 20. The first electrodes 18 and the second electrodes 20 are alternately stacked on top of another with sheet-shaped separators 21 disposed therebetween. Each of the first electrodes 18 includes a first current collector 22 and a first active material. Each of the second electrodes 20 includes a second current collector 24 and a second active material.

One of the first electrode 18 and the second electrode 20 is a positive electrode and the other is a negative electrode. The positive electrode includes a positive electrode current collector and a positive electrode active material. The negative electrode includes a negative electrode current collector and a negative electrode active material. Therefore, one of the first current collector 22 and the second current collector 24 is a positive electrode current collector and the other is a negative electrode current collector. In FIG. 3A and FIG. 3B, the first electrode 18 serves as a positive electrode and the second electrode 20 serves as a negative electrode to facilitate the understanding of the invention. That is, the first current collector 22 is a positive electrode current collector and the second current collector 24 is a negative electrode current collector. In FIG. 3A and FIG. 3B, since it is difficult to differentiate an electrode and a current collector, the electrode and the current collector are illustrated by the same element.

The first current collector 22 (positive electrode current collector) includes a first metal porous body and the second current collector 24 (negative electrode current collector) includes a second metal porous body. Herein, the first metal is preferably aluminum or an aluminum alloy and the second metal is preferably copper or a copper alloy. The positive electrode current collector preferably has a thickness of 0.1 to 10 mm. The negative electrode current collector preferably also has a thickness of 0.1 to 10 mm.

The first current collector 22 (positive electrode current collector) is particularly preferably Aluminum-Celmet (registered trademark of Sumitomo Electric Industries, Ltd.) because it has a high porosity (e.g., 90% or more), includes continuous pores, and substantially does not include closed pores. The second current collector 24 (negative electrode current collector) is also particularly preferably Celmet (registered trade of Sumitomo Electric Industries, Ltd.) of copper or nickel for the same reason. Celmet or Aluminum-Celmet will be described in detail later.

The first current collector 22 includes a tab-shaped first connection portion 26. Similarly, the second current collector 24 can include a tab-shaped second connection portion 28. Each of the connection portions is preferably made of the same material as that of a main body of the current collector and formed integrally with the main body. First conductive spacers 30 are disposed between the first connection portions 26 of the plurality of first current collectors 22. Similarly, second conductive spacers 32 can be disposed between the second connection portions 28 of the plurality of second current collectors 24.

Each of the first conductive spacers 30 can be formed of a plate-shaped member containing a conductor (e.g., metal and carbon material). For the purpose of improving the adhesion with the first connection portion 26, however, the first conductive spacer 30 is preferably formed of a metal porous body (third metal porous body) and particularly preferably formed of the same material (e.g., Aluminum-Celmet) as that of the first current collector 22. Similarly, each of the second conductive spacers can also be formed of a plate-shaped member containing a conductor (e.g., metal and carbon material). The second conductive spacer 32 is also preferably formed of a metal porous body (fourth metal porous body) and particularly preferably formed of the same material (e.g., Celmet of copper) as that of the second current collector 24.

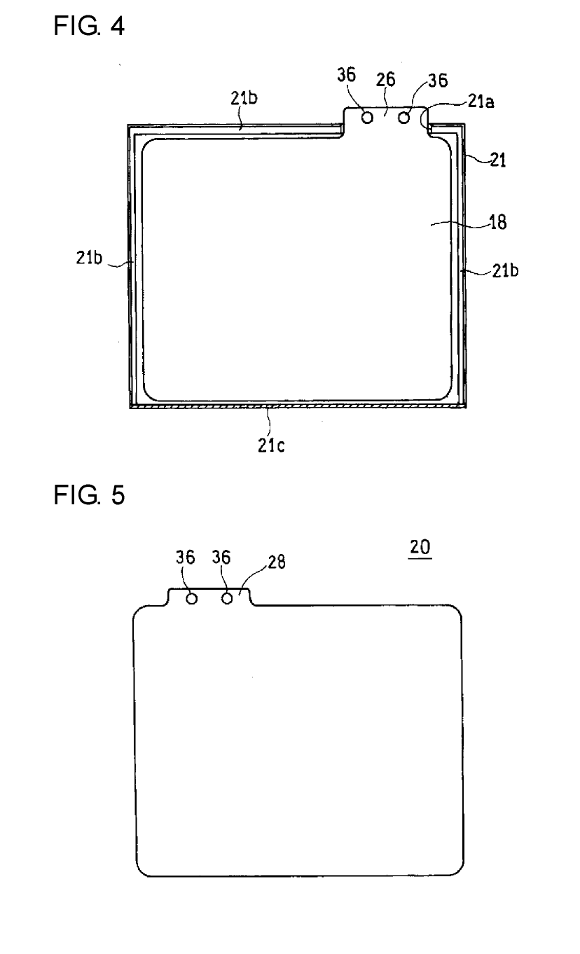

As illustrated in FIG. 4, each of the separators 21 is preferably formed in a bag-like shape so as to accommodate the first electrode 18 (positive electrode). The bag of the separator 21 can be formed by, for example, folding a rectangular separator 21 along a center line 21c in the longitudinal direction and sticking edges 21b other than an opening with glue. The bag-shaped separator 21 can include an opening 21a from which the connection portion protrudes. This can prevent an internal short-circuit from being caused when the positive electrode active material is detached from the first current collector 22.

As illustrated in FIG. 4, a through-hole 36 into which a first fastening member 34 such as a rivet is to be inserted can be formed in the first connection portion 26 of the first electrode 18. The number (two in the drawing) of through-holes 36 formed can be appropriately selected. The first connection portion 26 is disposed at a position close to one end of a side, along which the first connection portion 26 is formed, of the first current collector 22. A through-hole 37 into which the first fastening member 34 is to be inserted can also be formed in the first conductive spacer 30 so as to overlap the through-hole 36 of the first connection portion 26. A through-hole 37 into which the second fastening member 38 is to be inserted can also be formed in the second conductive spacer 32 so as to overlap the through-hole 36 of the second connection portion 28.

Although not particularly limited, the ratio of the projected area of the first connection portion 26 (the area of the first connection portion viewed in a direction perpendicular to the principal surface of the first current collector) to the projected area of the entire first current collector 22 can be 0.1 to 10%. Alternatively, the projected area of the first connection portion 26 or the length of the borderline between the main body of the first current collector and the first connection portion can be determined in accordance with the capacitance of the electricity storage device. The borderline is, for example, a straight line extending along the same axis as that of the side, of the first current collector, along which the first connection portion is disposed. The shape of the first connection portion 26 is not particularly limited, and may be a square shape with rounded corners.

FIG. 5 is a front view illustrating the second electrode 20 viewed in the same direction as that of the first electrode 18 in FIG. 4. Similarly, a through-hole 36 into which the second fastening member 38 such as a rivet is to be inserted can be formed in the second connection portion 28 of the second electrode 20. The second connection portion 28 is disposed at a position close to the other end of a side, along which the second connection portion 28 is formed, of the second current collector 24. Thus, when the first electrode 18 and the second electrode 20 are stacked on top of another, the first connection portion 26 and the second connection portion 28 are arranged at positions substantially symmetrical to each other. In the case where the second electrode 20 is a negative electrode, the outer shape of the main body of the second electrode 20 (second current collector 24) has substantially the same size as the bag-shaped separator 21. That is, the outer shape of the negative electrode is larger than that of the positive electrode. Thus, the entire positive electrode can be made to face the negative electrode with the separator disposed therebetween.

The first fastening member 34 is preferably formed of the same conductive material as that of the first current collector 22 in terms of achieving high corrosion resistance. Similarly, the second fastening member 38 is also preferably formed of the same conductive material as that of the second current collector 24.

The first connection portions 26 of the plurality of first electrodes 18 are arranged so as to overlap one another in the stacking direction of the electrode group 12, and therefore the through-holes 36 in the first connection portions 26 are also arranged in a straight line. The first conductive spacers 30 are also arranged so that the through-holes 37 are in line with the corresponding through-holes 36. The first fastening member 34 is inserted into the through-holes 36 and 37 arranged in a straight line, and, for example, the tip (head portion) of the first fastening member 34 is squashed to increase the diameter of the head portion. Thus, the plurality of first connection portions 26 are fastened to each other. Similarly, the plurality of second connection portions 28 are also fastened to each other by the second fastening member 38 inserted into the through-holes 36 and 37 arranged in a straight line.

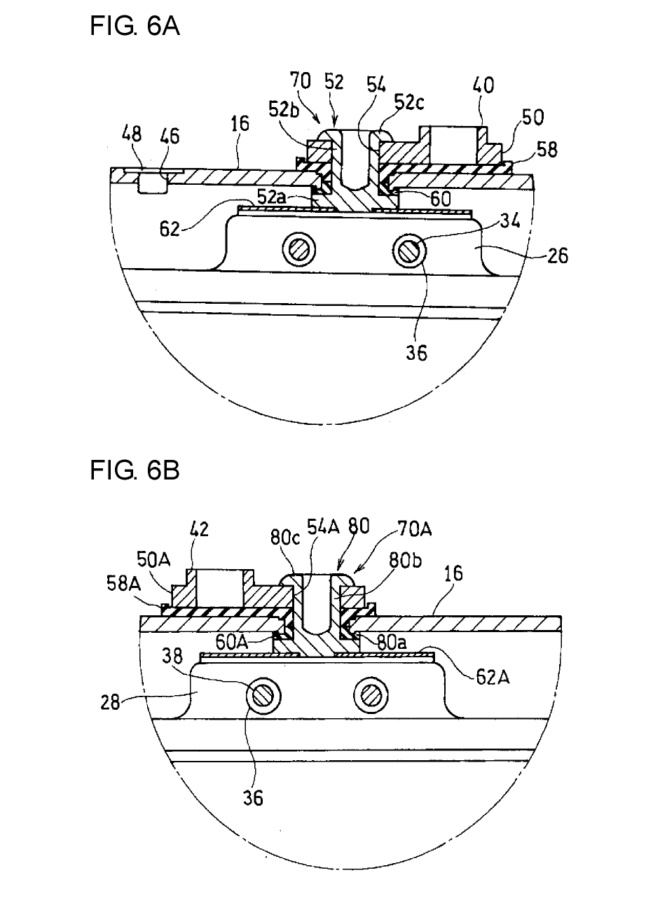

The sealing plate 16 includes a first external terminal 40 electrically connected to the plurality of first electrodes 18 and a second external terminal 42 electrically connected to the plurality of second electrodes 20. A safety valve 44 is disposed in the center of the sealing plate 16, and a liquid stopper 48 for covering a liquid injection hole 46 is disposed on the sealing plate 16 at a position close to the first external terminal 40 (refer to FIG. 6A).

FIG. 6A is an enlarged view illustrating a connection structure of the first electrode and the first external terminal (first terminal plate).

FIG. 6B is an enlarged view illustrating a connection structure of the second electrode and the second external terminal (second terminal plate). The first external terminal 40 is disposed at a position close to one end of a first terminal plate 50 made of, for example, a rectangular plate-shaped conductor. A through-hole is formed in the sealing plate 16, and a through-hole 54 is formed at a position close to the other end of the first terminal plate 50 so as to correspond to the through-hole. The first terminal plate 50 is fixed to the sealing plate 16 by a third fastening member (first rivet) 52 inserted into the through-hole 54. The first terminal plate 50 and the third fastening member 52 are electrically insulated from the sealing plate 16 by a plate-shaped gasket 58 and a ring-shaped gasket 60 each having a through-hole into which the third fastening member 52 is inserted. The plate-shaped gasket 58 and the ring-shaped gasket 60 constitute a first gasket.

A first lead 62 for electrically connecting the first electrodes 18 and the first external terminal 40 is joined to an end of the third fastening member 52 located inside the case 14 (refer to FIG. 3A). The second electrodes 20 and the second external terminal 42 are electrically connected to each other through a second lead 64 (refer to FIG. 3B).

The second external terminal 42 is disposed at a position close to one end of a second terminal plate 50A made of, for example, a rectangular plate-shaped conductor. A through-hole is formed in the sealing plate 16, and a through-hole 54A is formed at a position close to the other end of the second terminal plate 50A so as to correspond to the through-hole. The second terminal plate 50A is fixed to the sealing plate 16 by a fourth fastening member (second rivet) 80 inserted into the through-hole 54A. The second terminal plate 50A and the fourth fastening member 80 are electrically insulated from the sealing plate 16 by a plate-shaped gasket 58A and a ring-shaped gasket 60A each having a through-hole into which the fourth fastening member 80 is to be inserted. The plate-shaped gasket 58A and the ring-shaped gasket 60A constitute a second gasket.

A second lead 64 for electrically connecting the second electrodes 20 and the second external terminal 42 is joined to an end of the fourth fastening member 80 located inside the case 14 (refer to FIG. 3B). The thickness of the second lead is equal to that of the first lead.

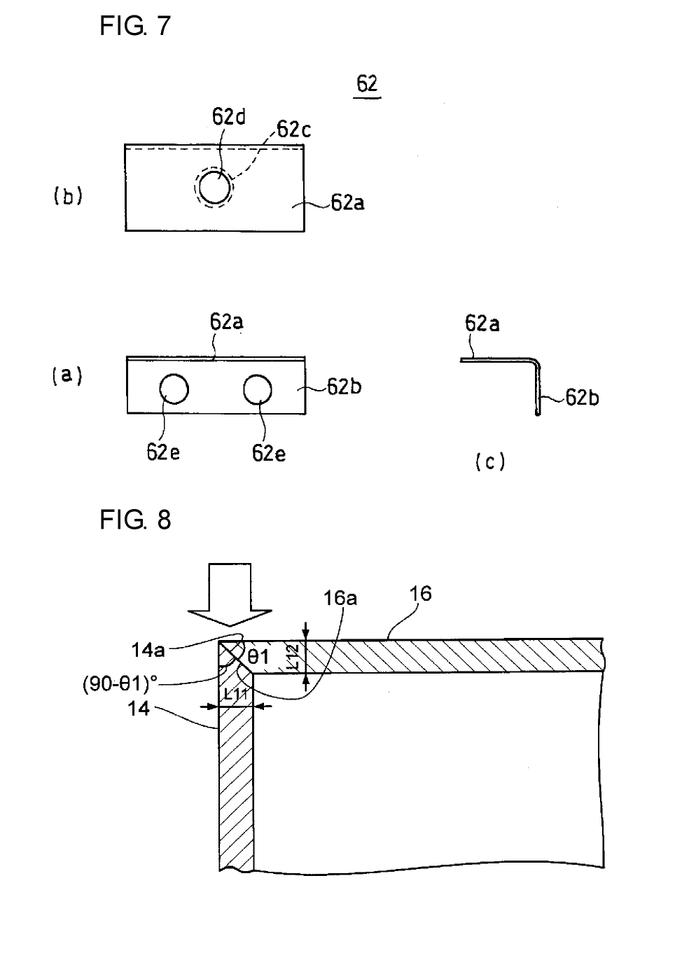

FIG. 7(a) is a front view illustrating an example of the first lead 62, FIG. 7(b) is a top view illustrating an example of the first lead 62, and FIG. 7(c) is a side view illustrating an example of the first lead 62. Since the structure of the second lead 64 is the same as that of the first lead 62, the drawings and description thereof are omitted.

The first lead 62 in the drawings is an L-shaped member in cross-sectional view, and includes a plate-shaped first portion 62a and a second portion 62b which are perpendicular to each other. The first portion 62a is a portion provided in parallel with the sealing plate 16 and includes, in the center thereof, a joint region 62c where the first lead 62 is joined to the third fastening member 52. The first lead 62 includes a fitting hole 62d formed inside the joint region 62c. A protruding portion formed at the end portion in the case 14 is fitted to the fitting hole 62d. The third fastening member 52 before deformation and the joint region 62c of the first lead 62 are joined by performing, for example, welding. This results in the formation of a first connection member 70 including the third fastening member 52 before deformation and the first lead 62 and used for connecting the first electrodes 18 and the first external terminal 40. The first connection member 70 can be produced in a line different from an assembly line of the electricity storage device 10, and thus can be supplied as a single part.

The second portion 62b is a portion provided so as to be perpendicular to the sealing plate 16. Mainly, as a result of the contact of the second portion 62b with the first connection portion 26, the first lead 62 is electrically connected to the first electrodes 18. The second portion 62b includes at least one through-hole 62e into which the first fastening member 34 is to be inserted. The second portion 62b is fixed to the first connection portion 26 while being in contact with the first connection portion 26 by the first fastening member 34 inserted into the through-hole 62e. Consequently, the first lead 62 is fixed to the first connection portions 26 of the plurality of first electrodes 18. The opening area of the through-hole 62e can be, for example, 0.005 to 4 cm². The opening shape is not particularly limited, and may be a circle or a polygon (e.g., regular hexagon). The number of through-holes 62e formed in the second portion 62b is not particularly limited, and may be in the range of 1 to 10. A single first fastening member 34 can be inserted into a corresponding single through-hole 62e to fix the first lead 62 to the first connection portions 26.

The first lead 62 preferably has a thickness of 0.1 to 2 mm. This can impart relatively high rigidity to the first lead 62. The first connection portion 26 has cushioning properties (ease of deformation). Therefore, the adhesion between the first connection portion 26 and the second portion 62b of the first lead 62 is easily ensured.

The third fastening member (first rivet) 52 includes a first large-diameter portion 52a located inside the sealing plate 16, a first expanding portion 52b inserted into the through-holes of the members (sealing plate 16, first terminal plate 50, and gaskets 58 and 60), and a first head portion 52c located outside the sealing plate 16. The sealing plate 16, the first terminal plate 50, and the first gasket (gaskets 58 and 60) are fastened all together by the first rivet while the third fastening member 52 is inserted into the above-described through-holes. Thus, the first terminal plate 50 is fixed onto the outer surface of the sealing plate 16. When the third fastening member 52 fastens the members, the cavity in the first expanding portion 52b expands and the diameter of the first expanding portion 52b increases. When the third fastening member 52 fastens the members, for example, the first head portion 52c is squashed and deformed so that the first head portion 52c and the first large-diameter portion 52a sandwich the first terminal plate 50, the sealing plate 16, and the gaskets 58 and 60.

As described above, in the connection structure illustrated in FIG. 6A, the first connection member 70 including the third fastening member 52 electrically connects the first electrodes 18 and the first external terminal 40. Therefore, by only fastening the members (sealing plate 16, first terminal plate 50, and gaskets 58 and 60) while the third fastening member 52 is inserted into the through-holes of the members (deforming the first expanding portion 52b and the first head portion 52c), the first terminal plate 50 can be fixed to the sealing plate 16 while being electrically insulated from the sealing plate 16. At the same time, by only performing such a single step, the first electrodes 18 and the first external terminal 40 can also be electrically connected to each other. Therefore, the first electrodes 18 and the first external terminal 40 can be electrically connected to each other and the first external terminal 40 can be disposed on the sealing plate 16 through a very simple process. This can ease the production of the electricity storage device 10 and can also shorten the production time.

The above process is the same mechanical joint method as in the case where connection portions of electrodes having the same polarity are fastened to each other. Therefore, the electricity storage device 10 can be assembled without using a resistance welder at all in an assembly line of the electricity storage device 10. This can simplify the assembly line.

Hereafter, the fourth fastening member having the same structure as the third fastening member will be described in detail. The fourth fastening member (second rivet) 80 includes a second large-diameter portion 80a located inside the sealing plate 16, a second expanding portion 80b inserted into the through-holes of the members (sealing plate 16, second terminal plate 50A, and gaskets 58A and 60A), and a second head portion 80c located outside the sealing plate 16. The fourth fastening member 80 fastens the sealing plate 16, the second terminal plate 50A, and the second gasket (gaskets 58A and 60A) all together while being inserted into the above-described through-holes. Thus, the second terminal plate 50A is fixed onto the outer surface of the sealing plate 16. When the fourth fastening member 80 fastens the members, the cavity in the second expanding portion 80b expands and the diameter of the second expanding portion 80b increases. When the fourth fastening member 80 fastens the members, for example, the second head portion 80c is squashed and deformed so that the second head portion 80c and the second large-diameter portion 80a sandwich the second terminal plate 50A, the sealing plate 16, and the gaskets 58A and 60A. The effects produced are the same as those described regarding the first connection member.

Next, a more preferable joint structure of the open edge of the case 14 and the sealing plate 16 will be described.

FIG. 8 is a partially enlarged view illustrating an open edge of the case 14. In the sealing structure in the drawing, the end portion (peripheral portion) of the sealing plate 16 includes an inclined surface 16a (first inclined surface) that forms an acute angle θ1 with the outer surface of the sealing plate. The upper end portion of the sidewall of the case 14 that forms the open edge includes an inclined surface 14a (second inclined surface) that forms an acute angle θ2 with the outer surface of the case 14. The peripheral portion of the sealing plate 16 and the open edge of the case 14 are joined by welding the inclined surfaces. Herein, when the outer surface of the sealing plate and the outer surface of the case are perpendicular to each other, θ2=(90−θ1) (degrees).

As described above, when the open edge of the case 14 and the peripheral portion of the sealing plate 16 are joined by welding the inclined surface 14a and the inclined surface 16a, they can be welded while sufficient adhesion is always achieved between the open edge of the case 14 and the peripheral portion of the sealing plate 16. For example, if a sealing plate 16 including a side surface (peripheral end surface) perpendicular to an outer surface (or inner surface) is welded to the inner surface of the open edge of the case 14 as illustrated in FIG. 9, the outer size of the sealing plate 16 needs to be precisely matched with the size of the open edge of the case 14 in order to improve the adhesion therebetween. If the outer size of the sealing plate 16 is not precisely matched with the size of the open edge of the case 14, a gap or a residual stress is generated between the end portion of the sealing plate 16 and the open edge of the case 14, which sometimes degrades the durability.

In the joint structure illustrated in FIG. 9, if the adhesion between the peripheral portion of the sealing plate 16 and the open edge of the case 14 is poor, foreign matter 90 generated due to sputtering or the like in laser welding may enter the case 14. In such a case, for example, an internal short-circuit is easily caused. It is difficult to find the entry of the foreign matter 90 into the case 14 through a visual inspection. In contrast, in the joint structure illustrated in FIG. 8, the end portion of the sealing plate 16 and the open edge of the case 14 can be laser-welded to each other while desired adhesion is always achieved by the contact between the inclined surfaces. This easily prevents the shipment of defective items. Herein, the angle θ1 is preferably in the range of 5 (degrees)≦θ1≦85 (degrees) and more preferably 10 (degrees)≦θ1≦45 (degrees).

When the angle θ1 is in the range of 5 (degrees)≦θ1≦85 (degrees), they can be welded by applying a laser from substantially vertically above the case 14 (in the direction of the normal to the outer surface of the sealing plate 16) but not from obliquely above the case 14. It is not easy to accurately apply a laser to a weld in an oblique direction because it is difficult to ensure the accuracy of image recognition and the accuracy of relative positions of the case and the sealing plate. When a laser is applied from vertically above, the end portion can be easily recognized and thus welding can be easily performed. Furthermore, by only two-dimensionally moving the case or a laser head, the entire peripheral portion of the sealing plate can be welded to the open edge of the case, which makes it easy to produce the electricity storage device.

Next, a metal porous body used as the first current collector 22 or the second current collector 24 will be described in detail.

The metal porous body preferably has a three-dimensional network hollow skeleton. A metal porous body with a skeleton having cavities therein has a bulky three-dimensional structure, but is extremely lightweight.

Such a metal porous body can be formed by plating a resin porous body having continuous voids with a metal constituting a current collector and then decomposing or dissolving the internal resin by performing a heat treatment or the like. As a result of the plating treatment, a three-dimensional network skeleton is formed. As a result of the decomposition or dissolution of the resin, the inside of the skeleton can be made hollow.

Any resin porous body may be used as long as it has continuous voids. Examples of the resin porous body include resin foams and nonwoven fabrics made of a resin. After the heat treatment, residual components in the skeleton (e.g., resins, decomposition products, unreacted monomers, and additives contained in the resin) may be removed by performing washing or the like.

Examples of the resin constituting the resin porous body include thermosetting resins such as thermosetting polyurethane and melamine resin; and thermoplastic resins such as olefin resins (e.g., polyethylene and polypropylene) and thermoplastic polyurethane. When a resin foam is used, individual pores formed inside the foam are caused to have a cellular form, though depending on the types of resins and the production method of the foam. The cells are caused to communicate with each other, and thus continuous voids are formed. In such a foam, the size of cellular pores tends to be small and uniform. In particular, when thermosetting polyurethane or the like is used, the size and shape of pores tend to become more uniform.

Any plating treatment may be employed as long as a metal layer that functions as a current collector can be formed on the surface (including the surface in the continuous voids) of the resin porous body. A publicly known plating treatment method such as an electrolytic plating method or a molten salt plating method can be employed. As a result of the plating treatment, a three-dimensional network metal porous body having a shape corresponding to that of the resin porous body is formed. When the plating treatment is performed by an electrolytic plating method, a conductive layer is desirably formed prior to the electrolytic plating. The conductive layer may be formed by, for example, performing non-electrolytic plating, vapor deposition, sputtering, or the like on the surface of the resin porous body or applying a conductive agent. Alternatively, the conductive layer may be formed by immersing the resin porous body in a dispersion liquid containing a conductive agent.

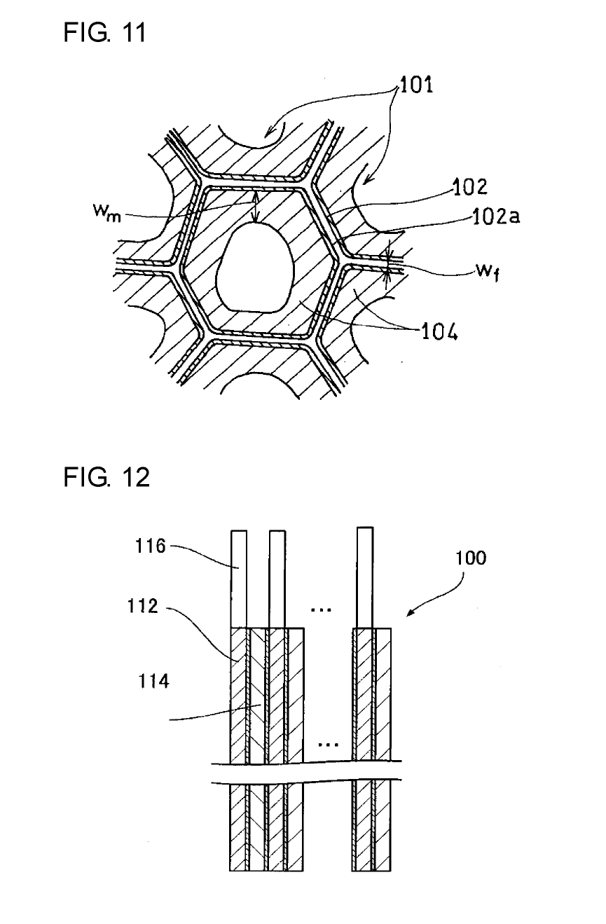

After the plating treatment, the resin porous body is removed by performing heating, whereby cavities are formed inside the skeleton of the metal porous body and thus a hollow skeleton is formed. The width of the cavities inside the skeleton (the width w_{f} of cavities in FIG. 11 described later) is, for example, 0.5 to 5 μm and preferably 1 to 4 μm or 2 to 3 μm on average. If necessary, the resin porous body can be removed by performing a heat treatment while a voltage is suitably applied to the resin porous body. Alternatively, a porous body subjected to the plating treatment is immersed in a molten salt plating bath and may be heat-treated while a voltage is applied to the porous body.

The metal porous body has a three-dimensional network structure having a shape corresponding to the shape of the resin foam. Specifically, the current collector includes continuous voids formed by connecting a large number of cellular pores included in individual metal porous bodies. An opening (or window) is formed between the adjacent cellular pores. The pores are preferably made to communicate with each other through this opening. The shape of the opening (or window) is not particularly limited, and is, for example, a substantially polygonal shape (e.g., substantially triangular shape, substantially tetragonal shape, substantially pentagonal shape, and/or substantially hexagonal shape). The term “substantially polygonal shape” refers to a polygon and a shape similar to a polygon (e.g., a polygonal shape whose corners are rounded and a polygonal shape whose sides are curved lines).

FIG. 10 schematically illustrates the skeleton of the metal porous body. The metal porous body includes a plurality of cellular pores 101 surrounded by a metal skeleton 102, and an opening (or window) 103 having a substantially polygonal shape is formed between the adjacent pores 101. The adjacent pores 101 communicate with each other through the opening 103, and thus the current collector includes continuous voids. The metal skeleton 102 defines the shape of each cellular pore and is three-dimensionally formed so as to connect pores. Thus, a three-dimensional network structure is formed.

The metal porous body has a very high porosity and a large specific surface area. That is, a large amount of active material can be attached in a large area including an area of the surface in the voids. Furthermore, since the contact area between the metal porous body and the active material and the porosity can be increased while the voids are filled with a large amount of active material, the active material can be effectively used. In the positive electrode for lithium ion capacitors or nonaqueous electrolyte secondary batteries, the conductivity is normally increased by adding a conductive assistant. When the above-described metal porous body is used as a positive electrode current collector, high conductivity is easily achieved even if the amount of the conductive assistant added is decreased. Therefore, the rate performance and energy density (and capacitance) of batteries can be effectively improved.

The specific surface area (BET specific surface area) of the metal porous body is, for example, 100 to 700 cm²/g, preferably 150 to 650 cm²/g, and more preferably 200 to 600 cm²/g.

The porosity of the metal porous body is, for example, 40 to 99 vol %, preferably 60 to 98 vol %, and more preferably 80 to 98 vol %. The average pore diameter (average diameter of cellular pores communicating with each other) in the three-dimensional network structure is, for example, 50 to 1000 μm, preferably 100 to 900 μm, and more preferably 350 to 900 μm. Herein, the average pore diameter is smaller than the thickness of the metal porous body (or electrode). The skeleton of the metal porous body is deformed by rolling, and the porosity and the average pore diameter change. The above-mentioned porosity and average pore diameter are a porosity and an average pore diameter of a metal porous body before rolling (before filling with a mixture).

The metal (the metal used for plating) constituting the positive electrode current collector for lithium ion capacitors or nonaqueous electrolyte secondary batteries is, for example, at least one selected from aluminum, an aluminum alloy, nickel, and a nickel alloy. The metal (the metal used for plating) constituting the negative electrode current collector for lithium ion capacitors or nonaqueous electrolyte secondary batteries is, for example, at least one selected from copper, a copper alloy, nickel, and a nickel alloy. The same metal (e.g., copper and copper alloy) as above can also be used for an electrode current collector for electric double layer capacitors.

FIG. 11 is a schematic sectional view illustrating a state in which the voids of the metal porous body in FIG. 10 are filled with an electrode mixture. The cellular pores 101 are filled with an electrode mixture 104, and the electrode mixture 104 adheres to the surface of the metal skeleton 102 to form an electrode mixture layer having a thickness wₘ. A cavity 102a having a width w_{f} is formed inside a skeleton 102 of the metal porous body. After the filling with the electrode mixture 104, a void is left so as to be surrounded by the electrode mixture layer in each of the cellular pores 101. After the metal porous body is filled with the electrode mixture, the metal porous body may be optionally rolled in the thickness direction, and thus an electrode is formed. FIG. 11 illustrates a state before the rolling. In the electrode obtained by the rolling, the skeleton 102 is slightly compressed in the thickness direction. The voids surrounded by the electrode mixture layer in the pores 101 and the cavity in the skeleton 102 are compressed. After the rolling of the metal porous body, the voids surrounded by the electrode mixture layer are still left to some extent, and thus the porosity of the electrode can be improved.

The positive electrode or the negative electrode is formed by, for example, filling the voids of the metal porous body obtained as described above with an electrode mixture and optionally compressing a current collector in the thickness direction. The electrode mixture contains an active material as an essential component and may contain a conductive assistant and/or a binder as an optional component.

The thickness wm of the mixture layer formed by filling the cellular pores of the current collector with the mixture is, for example, 10 to 500 μm, preferably 40 to 250 μm, and more preferably 100 to 200 μm. In order to provide the voids surrounded by the mixture layer formed in the cellular pores, the thickness wm of the mixture layer is preferably 5% to 40% and more preferably 10% to 30% of the average pore diameter of the cellular pores.

A material that intercalates and deintercalates alkali metal ions can be used as a positive electrode active material for nonaqueous electrolyte secondary batteries. Examples of such a material include metal chalcogen compounds (e.g., sulfides and oxides), alkali metal-containing transition metal oxides (lithium-containing transition metal oxide and sodium-containing transition metal oxide), and alkali metal-containing transition metal phosphates (e.g., iron phosphate having an olivine structure). These positive electrode active materials can be used alone or in combination of two or more.

A material that intercalates and deintercalates alkali metal ions such as lithium ions can be used as a negative electrode active material for lithium ion capacitors or nonaqueous electrolyte secondary batteries. Examples of such a material include carbon materials, spinel-type lithium titanium oxide, spinel-type sodium titanium oxide, silicon oxide, silicon alloys, tin oxide, and tin alloys. Examples of the carbon material include graphite, graphitizable carbon (soft carbon), and non-graphitizable carbon (hard carbon).

A first carbon material that adsorbs and desorbs anions can be used as a positive electrode active material for lithium ion capacitors. A second carbon material that adsorbs and desorbs organic cations can be used as an active material for one electrode for electric double layer capacitors, and a third carbon material that adsorbs and desorbs anions can be used as an active material for the other electrode. Examples of the first to third carbon materials include carbon materials such as activated carbon, graphite, graphitizable carbon (soft carbon), and non-graphitizable carbon (hard carbon).

The type of conductive assistant is not particularly limited, and examples of the conductive assistant include carbon blacks such as acetylene black and Ketjenblack; conductive fibers such as carbon fibers and metal fibers; and nanocarbon such as carbon nanotube. The amount of the conductive assistant is not particularly limited, and is, for example, 0.1 to 15 parts by mass and preferably 0.5 to 10 parts by mass relative to 100 parts by mass of the active material.

The type of binder is not particularly limited, and examples of the binder include fluororesins such as polyvinylidene fluoride (PVDF) and polytetrafluoroethylene; chlorine-containing vinyl resins such as polyvinyl chloride; polyolefin resins; rubber polymers such as styrene-butadiene rubber; polyvinylpyrrolidone and polyvinyl alcohol; cellulose derivatives (e.g., cellulose ethers) such as carboxymethyl cellulose; and polysaccharides such as xanthan gum. The amount of the binder is not particularly limited, and is, for example, 0.5 to 15 parts by mass, preferably 0.5 to 10 parts by mass, and more preferably 0.7 to 8 parts by mass relative to 100 parts by mass of the active material.

The thickness of the first electrodes 18 and the second electrodes 20 is 0.2 mm or more, preferably 0.5 mm or more, and more preferably 0.7 mm or more. The thickness of the first electrodes 18 and the second electrodes 20 is 5 mm or less, preferably 4.5 mm or less, more preferably 4 mm or less or 3 mm or less. These lower limits and upper limits can be freely combined. The thickness of the first electrodes 18 and the second electrodes 20 may be 0.5 to 4.5 mm or 0.7 to 4 mm.

The separators 21 have ionic permeability and are disposed between the first electrodes 18 and the second electrodes 20 to prevent a short-circuit between the electrodes. Each of the separators 21 has a porous structure and retains an electrolyte in the pores, whereby ions permeate through the separator 21. The separator 21 is, for example, a microporous film or a nonwoven fabric (including paper). The separator 21 is made of, for example, polyolefin such as polyethylene or polypropylene; polyester such as polyethylene terephthalate; polyamide; polyimide; cellulose; or glass fiber. The thickness of the separator 21 is, for example, about 10 to 100 μm.

The electrolyte for lithium ion capacitors contains a salt of a lithium ion and an anion (first anion). Examples of the first anion include fluorine-containing acid anions (e.g., PF₆⁻ and BF₄), chlorine-containing acid anions (ClO₄⁻), bis(oxalato)borate anions (BC₄O₈⁻), bis(sulfonyl)amide anions, and trifluoromethanesulfonic acid ions (CF₃SO₃⁻).

The electrolyte for electric double layer capacitors contains a salt of an organic cation and an anion (second anion). Examples of the organic cation include tetraethylammonium ions (TEA⁺), triethylmonomethylammonium ions (TEMA⁺), 1-ethyl-3-methylimidazolium ions (EMI⁺), and N-methyl-N-propylpyrrolidinium ions (MPPY⁺). The same anion as the first anion is used as the second anion.

The electrolyte for nonaqueous electrolyte secondary batteries contains a salt of an alkali metal ion and an anion (third anion). For example, the electrolyte for lithium ion batteries contains a salt of a lithium ion and an anion (third anion). The electrolyte for sodium ion batteries contains a salt of a sodium ion and an anion (third anion). The same anion as the first anion is used as the third anion.

The electrolyte may contain a nonionic solvent or water for dissolving the above salt or may be a molten salt containing the above salt. Examples of the nonionic solvent include organic solvents such as organic carbonates and lactones. When the electrolyte contains a molten salt, the content of the salt (an ionic substance constituted by an anion and a cation) in the electrolyte is preferably 90 mass % or more in view of improving heat resistance.

The cation constituting the molten salt is preferably an organic cation. Examples of the organic cation include nitrogen-containing cations; sulfur-containing cations; and phosphorus-containing cations. The anion constituting the molten salt is preferably a bis(sulfonyl)amide anion. Among the bis(sulfonyl)amide anions, for example, bis(fluorosulfonyl)amide anions (N(SO₂F)₂⁻, FSA⁻); bis(trifluoromethylsulfonyl)amide anions (N(SO₂CF₃)₂⁻, TFSA⁻), and bis(fluorosulfonyl)(trifluoromethylsulfonyl)amide anions (N(SO₂F)(SO₂CF₃)⁻) are preferred.

Examples of the nitrogen-containing cations include quaternary ammonium cations, pyrrolidinium cations, pyridinium cations, and imidazolium cations.

Examples of the quaternary ammonium cations include tetraalkylammonium cations (e.g., tetraC₁₋₁₀alkylammonium cations) such as tetramethylammonium cations, ethyltrimethylammonium cations, hexyltrimethylammonium cations, tetraethyammonium cations (TEA⁺), and methyltriethylammonium cations (TEMA⁺).

Examples of the pyrrolidinium cations include 1,1-dimethylpyrrolidinium cations, 1,1-diethylpyrrolidinium cations, 1-ethyl-1-methylpyrrolidinium cations, 1-methyl-1-propylpyrrolidinium cations (MPPY⁺), 1-butyl-1-methylpyrrolidinium cations (MBPY⁺), and 1-ethyl-1-propylpyrrolidinium cations.

Examples of the pyridinium cations include 1-alkylpyridinium cations such as 1-methylpyridinium cations, 1-ethylpyridinium cations, and 1-propylpyridinium cations.

Examples of the imidazolium cations include 1,3-dimethylimidazolium cations, 1-ethyl-3-methylimidazolium cations (EMI⁺), 1-methyl-3-propylimidazolium cations, 1-butyl-3-methylimidazolium cations (BMI⁺), 1-ethyl-3-propylimidazolium cations, and 1-butyl-3-ethylimidazolium cations.

Examples of the sulfur-containing cations include tertiary sulfonium cations, e.g., trialkylsulfonium cations (e.g., triC₁₋₁₀halkylsulfonium cations) such as trimethylsulfonium cations, trihexylsulfonium cations, and dibutylethylsulfonium cations.

Examples of the phosphorus-containing cations include quaternary phosphonium cations, e.g., tetraalkylphosphonium cations (e.g., tetraC₁₋₁₀alkylphosphonium cations) such as tetramethylphosphonium cations, tetraethylphosphonium cations, and tetraoctylphosphonium cations; and alkyl(alkoxyalkl)phosphonium cations (e.g., triC₁₋₁₀alkyl(C₁₋₅alkoxyC₁₋₅alkyl)phosphonium cations) such as triethyl(methoxymethyl)phosphonium cations, diethylmethyl(methoxymethyl)phosphonium cations, and trihexyl(methoxyethyl)phosphonium cations.

### Second Embodiment

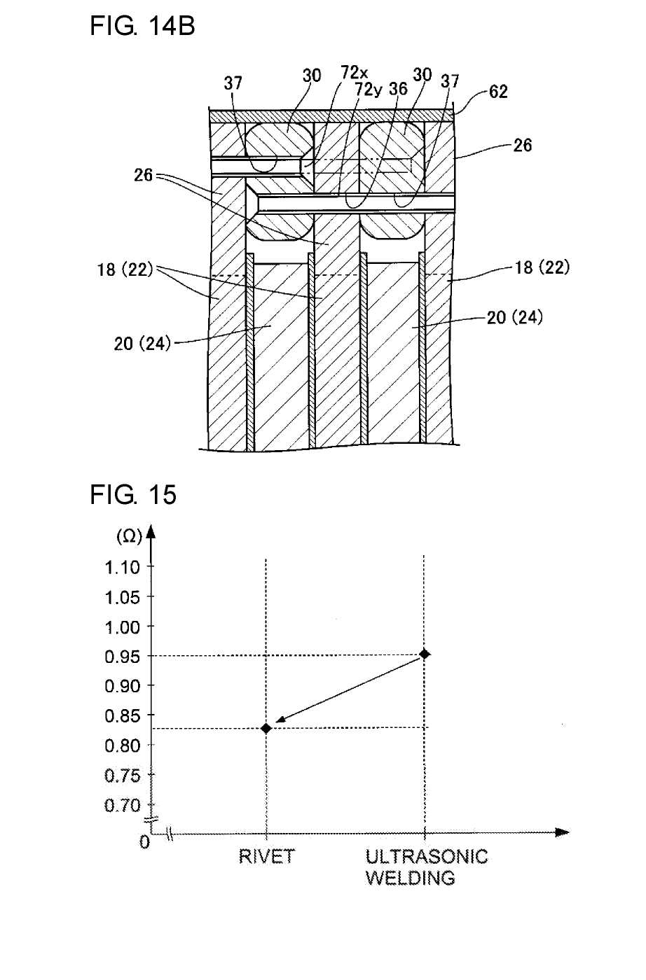

Next, a second embodiment of the present invention will be described with reference to FIG. 14A and FIG. 14B.

FIG. 14A is a sectional view of the electrode group illustrating an enlarged principal part of a fastening structure in which the first connection portions of the plurality of first electrodes are fastened to each other. In the electricity storage device according to this embodiment, as illustrated in FIG. 14A, a countersunk-head rivet 72 is used as at least one of the first fastening member and the second fastening member (the first fastening member in the drawing). In the example illustrated in FIG. 14A, the first connection portions 26 of all the first electrodes 18 of the electrode group 12 are fastened to each other using a single countersunk-head rivet 72.

More specifically, the countersunk-head rivet 72 includes a shaft portion 72a inserted into the through-holes 36 of the first connection portions 26 and the through-holes 37 of the first conductive spacers 30 and a head portion 72b engaged with a first connection portion 26 (the first connection portion on the right side in the drawing, temporarily referred to as a right-end connection portion) of an outermost first electrode 18 among the plurality of stacked first electrodes 18. The top surface of the head portion 72b (the end surface of the countersunk-head rivet on the head portion side in the axial direction) is a flat surface. A countersunk hole 74 having a shape corresponding to the shape of the head portion 72b is formed on the outer surface of the right-end connection portion (the surface on the right side in the drawing). The countersunk-head rivet 72 fastens the first connection portions 26 while the entire head portion 72b is sunk in the countersunk hole 74. Alternatively, the first connection portions 26 can also be fastened to each other by further disposing a first conductive spacer on the outside of the right-end connection portion and sinking the head portion 72b of the countersunk-head rivet 72 in the first conductive spacer.

As described above, the use of the countersunk-head rivet 72 as the first fastening member 34 can prevent the head portion of the first fastening member from protruding from the surface of the first connection portion located at the end of the electrode group 12 in the stacking direction. This can reduce the number of protrusions that protrude from the end surface of the electrode group in the stacking direction. Therefore, the electrode group can be easily accommodated in the case of the electricity storage device. This makes it easy to produce the electricity storage device. The reduction in the number of protrusions can also improve the space utilization in the case. Furthermore, the number of protrusions that protrude from the end surface of the electrode group 12 can be reduced by fastening the second connection portions 28 of the plurality of second electrodes 20 to each other using the countersunk-head rivet 72 as the second fastening member 38. This further makes it easy to produce the electricity storage device and can further improve the space utilization in the case.

Even if the diameter of the head portion 72b is relatively increased, the space utilization in the case does not reduce. Therefore, the diameter of the head portion 72b can be increased so that the first connection portions can be fastened to each other with sufficient strength. This can improve the durability of the electrode group. Furthermore, the diameter of the head portion 72b can be increased to a diameter larger than that of typical rivets, and the head portion 72b and the countersunk hole 74 are in contact with each other along an inclined surface. Therefore, the contact area between the first fastening member 34 and the first connection portion 26 (or first conductive spacer 30) can also be increased. This can decrease the contact resistance between the first fastening member and the first connection portion. Thus, the conductivity between the first electrode and the first lead through the first fastening member can be improved. Accordingly, the discharge characteristics of the electricity storage device can also be improved.

FIG. 14B illustrates a modification of this embodiment. As in FIG. 14A, FIG. 14B is also an enlarged view illustrating a principal part of a fastening structure in which the first connection portions of the plurality of first electrodes are fastened to each other. However, FIG. 14B focuses on a first connection portion of a first electrode located around the center in the stacking direction of the plurality of first electrodes.

In the drawing, the first connection portions 26 of the plurality of first electrodes 18 are fastened to each other using a plurality of (two in the drawing) countersunk-head rivets 72 serving as the first fastening member 34. Herein, the first connection portions of some of the plurality of stacked first electrodes (first group) are fastened to each other using one of the countersunk-head rivets, and the first connection portions of the remaining first electrodes (second group) are fastened to each other using the other of the countersunk-head rivets. The first group is a group of first electrodes arranged on the left side of a first conductive spacer 30 (temporarily referred to as a central spacer; in the example of FIG. 14B, a spacer on the left side of the two first conductive spacers 30) located around the center in the stacking direction of the electrode group 12. The second group is a group of first electrodes arranged on the right side of the central spacer.

In the drawing, the first connection portions 26 of the first electrodes 18 in the first group are fastened to each other together with the central spacer using a countersunk-head rivet 72x. The first connection portions 26 of the first electrodes 18 in the second group are also fastened to each other together with the central spacer using another countersunk-head rivet 72y. The head portions 72a of the countersunk-head rivets are sunk in the central spacer from opposite surfaces of the central spacer.

As described above, in this modification, a plurality of rivets share at least one member (herein, the first conductive spacer 30) and the individual rivets fasten the first connection portions 26 of the plurality of first electrodes 18 in the different groups. Thus, the first connection portions 26 of a desired number of first electrodes 18 can be fastened to each other without using an especially long rivet. By using the countersunk-head rivet 72 as the first fastening member 34, the head portion 72b of the countersunk-head rivet 72 can be sunk in the member to be fastened. Such an arrangement of the plurality of rivets can fasten the first connection portions 26 of all the first electrodes 18 of the electrode group 12.

The member shared by the plurality of rivets is not limited to the first conductive spacer illustrated in the drawing. The plurality of rivets can share a first connection portion of the same first electrode, and the individual rivets can fasten the first connection portions of the plurality of different first electrodes. The number of members shared by the plurality of rivets is not limited to one. FIG. 14B also illustrates another example of the countersunk-head rivet 72x, which is shown by a chain double-dashed line. The plurality of rivets can share a plurality of members (three in the drawing), and the individual rivets can fasten the first connection portions of the plurality of different first electrodes.

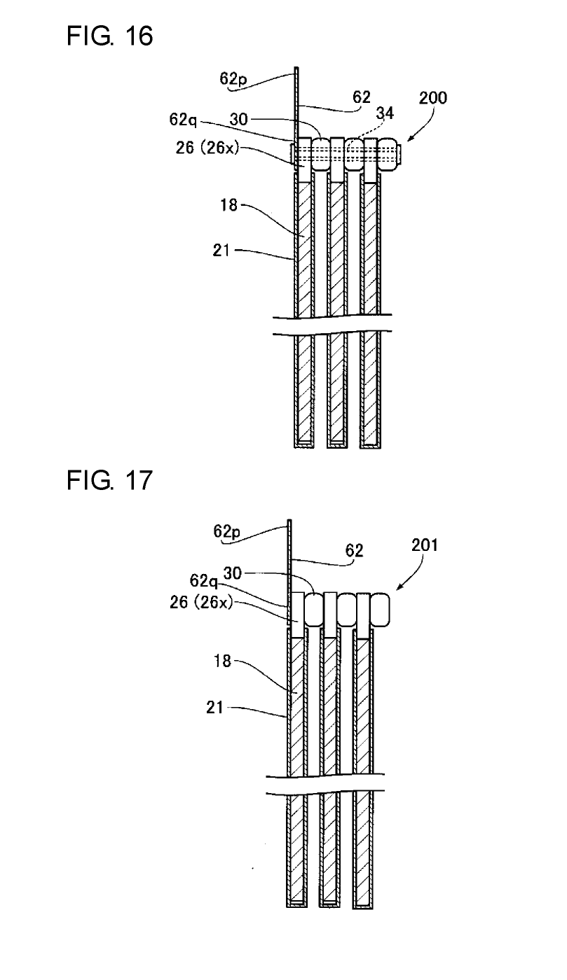

FIG. 15 is a graph illustrating the connection resistance between the electrodes and the lead in the electrode group having the same structure as in the first embodiment. More specifically, as illustrated in FIG. 16, a test electrode group 200 including three first electrodes 18 including a metal porous body and separators 21 was prepared. First conductive spacers 30 including a metal porous body were sandwiched between the first connection portions 26 of the first electrodes 18. The first connection portions 26 of the first electrodes 18 were joined to each other by a rivet 34. As a result of the fastening with the rivet 34, a first lead 62 had one end portion 62q pressure-bonded to a first connection portion 26 (26x) of a first electrodes 18 located at the end of the electrode group 200 in the stacking direction of the electrode group 200 (first test product). For five first test products, the electrical resistance Ra between the first connection portion 26x and a free end portion 62p of the first lead 62 was measured by a four-terminal method. The electrical resistance Ra was 0.83Ω on average (refer to FIG. 15).

Furthermore, as illustrated in FIG. 17, first conductive spacers 30 were sandwiched between the first connection portions 26 of three first electrodes 18, and one end portion 62q of a first lead 62 was brought into contact with the first connection portion 26x. The members were subjected to ultrasonic welding to produce an electrode group 201 (second test product). For five second test products, the electrical resistance Rb between the first connection portion 26x and a free end portion 62p of the first lead 62 was measured by a four-terminal method. The electrical resistance Rb was 0.95Ω on average (refer to FIG. 15).

It was confirmed that, when the electrodes include a current collector formed of a metal porous body, the connection resistance can be reduced by mechanically joining the electrodes using a rivet compared with the case where the electrodes were joined by welding. The variation in the electrical resistance Rb obtained by measuring the five second test products was larger than the variation in the electrical resistance Ra obtained by measuring the five first test products. Thus, it was confirmed that a low connection resistance is stably achieved by mechanically joining electrodes and a lead using a rivet.

The above description includes the following features.

### Appendix 1

An electrode group comprising:

a plurality of first electrodes including sheet-shaped first current collectors and a first active material carried on the first current collectors;

a plurality of second electrodes including sheet-shaped second current collectors and a second active material carried on the second current collectors; and

sheet-shaped separators disposed between the first electrodes and the second electrodes,

wherein the first electrodes and the second electrodes are alternately stacked with the separators disposed between the first electrodes and the second electrodes,

the first current collectors each include a first metal porous body,

the plurality of first current collectors include tab-shaped first connection portions each used to electrically connect the first current collectors adjacent to each other, and

the first connection portions of the plurality of first current collectors are disposed so as to overlap one another in a stacking direction of the electrode group with sheet-shaped first conductive spacers disposed therebetween, and are fastened to each other by a first fastening member.

### Appendix 2

The electrode group according to Appendix 1, wherein the first electrodes have a thickness of 0.1 to 10 mm.

### Appendix 3

The electrode group according to Appendix 1, wherein each of the first conductive spacers is disposed between the two adjacent first connection portions while being compressed, and the first conductive spacers have a compression ratio of 1/10 to 9/10.

### Appendix 4

The electrode group according to Appendix 1, wherein each of the first conductive spacers is disposed between the two adjacent first connection portions while being compressed, and the first conductive spacers have a compression stress of 0.01 to 1 MPa.

### Appendix 5

The electrode group according to Appendix 1, wherein the chamfered portion has a radius of curvature of 1 to 10 mm.

### Appendix 6

The electrode group according to Appendix 1, wherein the first metal porous body is a metal porous body having a three-dimensional network structure and containing aluminum.

### Appendix 7

The electrode group according to Appendix 1, wherein the second metal porous body is a metal porous body having a three-dimensional network structure and containing copper.

### Appendix 8

The electrode group according to Appendix 1, wherein the first conductive spacers each include a third metal porous body, and the third metal porous body is a metal porous body having a three-dimensional network structure and containing aluminum.

### Appendix 9

The electrode group according to Appendix 1, wherein the second conductive spacers each include a fourth metal porous body, and the fourth metal porous body is a metal porous body having a three-dimensional network structure and containing copper.

### INDUSTRIAL APPLICABILITY

The present invention can be widely applied to electricity storage devices such as lithium ion batteries, sodium ion batteries, lithium ion capacitors, and electric double layer capacitors.

### REFERENCE SIGNS LIST

10 electricity storage device
100 positive electrode active material
101 pore
102 skeleton
102a cavity
103 opening
104 positive electrode mixture
12 electrode group
14 case
14a, 16a inclined surface
16 sealing plate
18 first electrode
20 second electrode
21 separator
21a open edge
21b edge
22 first current collector
24 second current collector
26 first connection portion
28 second connection portion
34 first fastening member
38 second fastening member
40 first external terminal
42 second external terminal
44 safety valve
50 first terminal plate
50A second terminal plate
52 third fastening member
58, 60 (first) gasket
58A, 60A (second) gasket
62 first lead
62A second lead
64 second lead
70 first connection member
70A second connection member
80 fourth fastening member
90 foreign matter

1. An electrode group comprising:
a plurality of first electrodes including sheet-shaped first current collectors and a first active material carried on the first current collectors;
a plurality of second electrodes including sheet-shaped second current collectors and a second active material carried on the second current collectors; and
sheet-shaped separators disposed between the first electrodes and the second electrodes,
wherein the first electrodes and the second electrodes are alternately stacked with the separators disposed between the first electrodes and the second electrodes,
the first current collectors each include a first metal porous body,
the plurality of first current collectors include tab-shaped first connection portions each used to electrically connect the first current collectors adjacent to each other, and
the first connection portions of the plurality of first current collectors are disposed so as to overlap one another in a stacking direction of the electrode group with sheet-shaped first conductive spacers disposed therebetween, and are fastened to each other by a first fastening member.

2. The electrode group according to claim 1,
wherein the second current collectors each include a second metal porous body,
the plurality of second current collectors include tab-shaped second connection portions each used to electrically connect the second current collectors adjacent to each other, and
the second connection portions of the plurality of second current collectors are disposed so as to overlap one another in the stacking direction of the electrode group with sheet-shaped second conductive spacers disposed therebetween, and are fastened to each other by a second fastening member.

3. The electrode group according to claim 1, wherein the first fastening member contains the same metal element as the first current collectors.

4. The electrode group according to claim 3,
wherein each of the first electrodes is a positive electrode, the first current collectors each contain aluminum or an aluminum alloy, and
the first fastening member contains aluminum or an aluminum alloy.

5. The electrode group according to claim 2,
wherein the second fastening member contains the same metal element as the second current collectors.

6. The electrode group according to claim 5,
wherein each of the second electrodes is a negative electrode, the second current collectors each contain copper or a copper alloy, and
the second fastening member contains copper or a copper alloy.

7. The electrode group according to claim 1, wherein the first conductive spacers each include a third metal porous body.

8. The electrode group according to claim 2, wherein the second conductive spacers each include a fourth metal porous body.

9. The electrode group according to claim 1, wherein the first conductive spacers each have a chamfered portion at a corner corresponding to at least one of sides that contact the first connection portions.

10. The electrode group according to claim 2, wherein the second conductive spacers each have a chamfered portion at a corner corresponding to at least one of sides that contact the second connection portions.

11. The electrode group according to claim 2, wherein at least one of the first fastening member and the second fastening member is a rivet.

12. The electrode group according to claim 11, wherein the rivet is a countersunk-head rivet.

13. An electricity storage device comprising the electrode group according to claim 1, an electrolyte, and a case that accommodates the electrode group and the electrolyte.

14. The electricity storage device according to claim 13, wherein the case is a metal can or a packaging container formed of a lamination film.

15. A lithium ion capacitor comprising the electrode group according to claim 1, an electrolyte, and a case that accommodates the electrode group and the electrolyte,
wherein the electrolyte contains a salt of a lithium ion and an anion, and
one of the first active material and the second active material is a first material that intercalates and deintercalates the lithium ion, and the other is a second material that adsorbs and desorbs the anion.

16. An electric double layer capacitor comprising the electrode group according to claim 1, an electrolyte, and a case that accommodates the electrode group and the electrolyte,
wherein the electrolyte contains a salt of an organic cation and an anion, and
one of the first active material and the second active material is a third material that adsorbs and desorbs the organic cation, and the other is a fourth material that adsorbs and desorbs the anion.

17. A nonaqueous electrolyte secondary battery comprising the electrode group according to claim 1, an electrolyte, and a case that accommodates the electrode group and the electrolyte,
wherein the electrolyte contains a salt of an alkali metal ion and an anion, and
both of the first active material and the second active material are materials that intercalate and deintercalate the alkali metal ion.
